(19) United States
(12) Patent Application Publication
(10) Pub. No.: US 2011/0006514 A1
(43) Pub. Date: Jan. 13, 2011

(54) CONNECTING AND FIXING STRUCTURE FOR A SHOWER HEAD

(75) Inventors: Renzhong Li, Xiamen (CN); Hao Deng, Xiamen (CN)

Correspondence Address: RABIN & Berdo, PC, 1101 14TH STREET, NW, SUITE 500, WASHINGTON, DC, 20005, US

(73) Assignees: Xiamen Solex High Tech Industries Co Ltd, Fujian (CN); Huasong Zhou, Fujian (CN)

(21) Appl. No.: 12/919,510

(22) PCT Filed: Apr. 7, 2009
(86) PCT No.: PCT/CN2009/071183

§ 371 Date: Aug. 26, 2010

(30) Foreign Application Priority Data
Apr. 9, 2008 (CN) 200810070899.9

(51) Int. Cl. F16L 37/133; B05B 1/18

(52) U.S. Cl. 285/148.2

(57) ABSTRACT

A connecting and fixing structure for a shower head comprises a connector formed in the shower head, a main joint connected to an outlet on the top of the wall, a movable fixing structure used for connecting the main joint and the connector; the movable fixing structure and the main joint may be assembled to form such a structure that can be moveably engaged. When the connector is inserted into the main joint, the connector is fixed on the main joint by the moveable fixing structure through the structure mentioned above and a neck on the connector. Therefore it is convenient and fast to assemble and disassemble the shower head.

### FIELD OF THE INVENTION

The present invention relates to a bath appliances, especially to a connecting and fixing structure for a shower head with rapid configuration.

### BACKGROUND OF THE INVENTION

Some shower heads connect to the outlet in the wall through a hose so as to hand held flexible; some other fix to the wall or the top of the wall directly so as to shower with fixed point.

With the update of the bath appliances and the difference needs of the consumers, the shower area has no longer limited to a small one, but to be larger and larger. A shower having large scale of sprinkle makes its panel larger and the outlet holes can distribute more, so that it can come into a sprinkle with large area.

When the shower head fixes to the outlet on the top of the walls, users can configure the shower heads with small size as in normal to the outlet joint or remove it with single hand. However, with larger panel, it can not configure or remove with single hand to rotatory fix, even more it would be time-consuming and hard.

### SUMMARY OF THE INVENTION

The objective of the present invention is to provide a connecting fixing structure for a shower head which can install the shower head to the outlet of the top of the wall quickly.

To achieve the objective above, the technology solution is: A connecting and fixing structure for a shower head comprises a connector formed in the shower head, a main joint connecting to an outlet on the top of the wall, a movable fixing structure used for connecting the main joint and the connector; the movable fixing structure is movable sleeved on the main joint and is movable stretched to the main joint to form an elastic hook, and the connector sticks to the inside of the main joint and hangs on the hook.

Said connector comprising an upper cylinder and a lower cylinder is a two-step stage column with thick above and thin down, besides the upper cylinder has a neck interspace, a groove is disposed on the top of the neck to embed an airproof ring.

The upper edge of said neck forms an inclined leading face.

The inside diameter of said main joint adapts to the outer diameter of the connector, and the outer edge of the main joint forms three steps of stage growing thin, which are the upper, middle and lower cylinder, and some symmetrical position holes are disposed close to the middle of the lower cylinder and a limit step is disposed at the bottom of the lower cylinder.

An inclined face is disposed at the bottom of the position holes. The movable fixing structure comprises a snap-fit, a spring and a sliding sleeve; plurality of convex feet extend inside and upside at the bottom of the snap-fit, which hitches to the main joint, and the convex feet are stretched to the position holes of the main joint, thus formed elastic hooks; the sliding sleeve is a sheath and the inside edge of the bottom of the sliding sleeve has flange ring, where plurality of position convex ribs extend inside and downside, and the spring places in the sliding sleeve downward; the bottom of the spring abut against the flange ring, and the sliding sleeve hitches to the main joint with the spring from the bottom of the main joint upward; the position convex ribs abut against the limit step at the bottom of the main joint, while the top of the spring abut against the step in the formation of the upper and the middle cylinder of the main joint. The flange ring of the sliding sleeve pushes alongside against the bottom of the snap-fit when normal.
The diameter surrounded by the top of the convex feet of the snap-fit is smaller than the outer diameter of the upper cylinder of the connector; steps are disposed at the outer edge of the top of the convex feet.

In the present invention, a movable fixing structure works with the main joint which connects to outlet on the top of the wall as a structure that has clipping movably. A neck is disposed in the connector which is molded in the shower head. When the connector stretches to the main joint, the movable fixing structure hangs on the main joint fixable, so that the shower head and the main joint could insert or plug to each other, making the configuration and the remove of the shower head with ease. A snap-fit used in the present invention as a clip is a sleeve ring, where plurality of convex feet extends inside and upside at the bottom, while equal amount of position holes are disposed correspondingly in the main joint. Consequently the clip matches stably, and the effect of the fixing structure is well.

### BRIEF DESCRIPTION OF THE DRAWINGS

FIG. 1 illustrates the connection of the present invention;

FIG. 2 illustrates the separate action diagram of the present invention;

FIG. 3 illustrates the separate state diagram of the present invention.

Connector 1, intake cavity 2, upper cylinder 11, lower cylinder 12, neck 111, groove 13; main joint 2, upper cylinder 21, middle cylinder 22, lower cylinder 23, position hole 231, inclined plane 232, limit step 233; movable fixing structure 3, snap-fit 31, convex foot 311, step 312, sliding sleeve 33, flange ring 331, position convex rib 332; airproof ring 4;

### DETAILED DESCRIPTION OF THE PREFERRED EMBODIMENTS

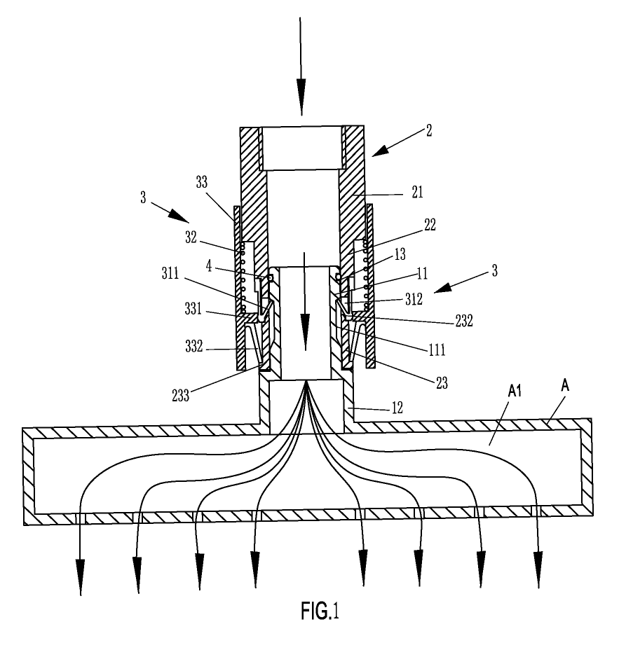

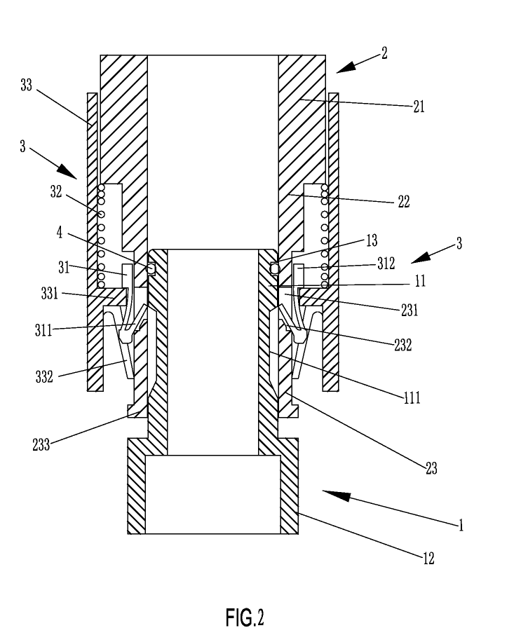

According to the FIG. 1 and FIG. 2, the connecting and fixing structure for a shower head in the present invention comprises a connector 1, a main joint 2 and a movable fixing structure 3 to connect both above;

The connector 1 is a cylinder forming on the back of the shower head A, communicating with the intake cavity A1 of the shower head A; the connector 1 comprising an upper cylinder 11 and a lower cylinder 12 is a two-step stage column with thick above and thin down, thereinto a neck 111 is disposed in the middle of the upper cylinder 11, and both of the upper edge and the lower edge of the neck 111 form a inclined leading face. The upper cylinder 11 above the neck 111 is disposed with a groove 13 to embed the airproof ring 4;

The main joint 2 is connected with the outlet on the top of the wall to be a water passage, the inner diameter of the main joint 2 adapts to the outer diameter of the upper cylinder 1 of the connector 1. The outer edge of the main joint 2 forms three steps of ladder growing thin, which are the upper 21, middle 22 and lower 23 cylinder. The three cylinder turns to be a stage. Some symmetrical position holes 231, whose bottom portion disposes an inclined face 232, are disposed close to the middle of the lower cylinder 23 and a limit step 233 is disposed at the bottom of the lower cylinder 23.

The movable fixing structure 3 comprises a snap-fit 31, a spring 32 and a sliding sleeve 33;

The snap-fit 31 is a sleeve ring, and plurality of convex feet 311 are extended inwardly and upwardly from the bottom of the snap-fit. The convex feet 311 have an equal amount to the position holes 231. The inner diameter surrounded by the end of the convex feet 311 is smaller than the outer diameter of the upper cylinder 11 of the connector 1, and the outer edge of the bottom of the convex feet has steps. The snap-fit 31 hitches the top of the lower cylinder 23 of the main joint 2, and the top of the snap-fit 31 abut against the step formed by the middle cylinder 22 and the lower cylinder 23. Especially the convex foot 311 stretches inside to the position hole 231 of the lower cylinder 23 of the main joint 2 to be an elastic hook. Because of the plurality of the convex feet 311 the snap-fit 31 has, all of the convex feet 311 stretch inside to the position holes 231 of the lower cylinder 23 of the main joint 2 to be elastic hooks, so that the affect of the position is well;

The sliding sleeve 33 is a cover column, whose inner diameter adapts to the upper cylinder of the main joint 2. The bottom of the inner is disposed with flange ring 331, whose inner diameter adapts to the outer diameter of the bottom of the snap-fit 31. A plurality of position convex ribs 332 extends inside and downside from the flange ring 331. As showed in the FIG. 1, the spring 32 place in the sliding sleeve 33 downwards, the bottom of the spring 32 abut against the flange ring 331, and the sliding sleeve 33 hitches to the main joint 2 with the spring 32 from the bottom of the main joint 2 upwards; the position convex ribs 332 abut against the limit step 233 at the bottom of the main joint 2, preventing the sliding sleeve 33 from shedding off the main joint 2. And the top of the spring 32 push against the step formed by the upper 21 and middle 22 cylinders of the main joint 2, so that the sliding bush 33 is movable in the main joint 2. The convex feet 311 of the snap-fit 31 support alongside against the neck 111 of the connector 1, and the side wall of the flange ring 331 of the sliding sleeve 33 abut against the outer edge at the bottom of the snap-fit 31 making it a fixation.

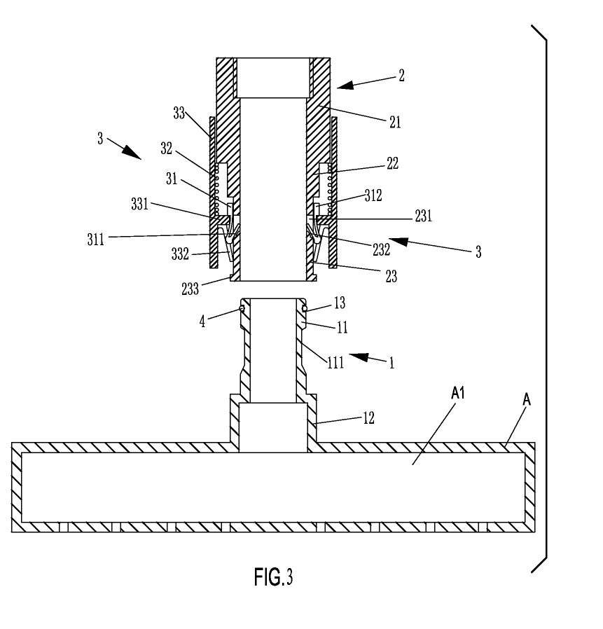

As showed in the FIG. 1 and FIG. 3, when going to fix the shower head to the main joint which connects to the outlet on the top of the wall, stick the connector 1 of the shower head directly to the inner cavity of the main joint 2. As the convex feet 311 of the snap-fit 31 is disposed upwards from inner sidelong, the connector 1 can push the convex feet 311 transmute outwards when the connector 1 goes upwards. While the neck 111 of the connector 1 moves up to the position of the snap-fit 31, the convex feet 311 of a hook is enclosing to the neck 111 and hanging the connector to be a fixation. That is the shower head A connecting to the outlet. Because of the airproof loop 4 disposed in the connector 1, the cavity between the connector 1 and the main joint 2 is sealed avoiding leaking.

As showed in the FIG. 2 and FIG. 3, when going to remove the shower head A out of the main joint 2, push the sliding sleeve 33 of the movable fixing structure 3 upwards comparatively to the main joint 2, at the time the spring 32 is compressed energy. Pull the shower head at the same time, making the connector 1 moves down comparatively to the main joint 2, the connector 1 would move down with the snap-fit 31. With the two-way force, the flange ring 331 of the sliding sleeve 33 will abut against the interspace of the snap-fit 31. The disposing of the step 312 could avoid the snap-fit 31 falling away from the sliding bush 33. At the process of the connector 1 force upwards, the inclined face in the neck 11 of the connector 1 will push against the convex feet 311 of the snap-fit 31. So that the convex feet 311 moves outwards sidelong back to the position holes 231 along the inclined plane 232 at the bottom of the position holes 231, losing the hanging fixation of the connector 1. Then the shower head removes out of the main joint.

Stated thus, the present invention has a movable clipping structure by the coordination of a movable fixing structure 3 and a main joint 2 connecting to the outlet on the top of the wall. A neck 111 is disposed in the connector 1 which molds in the shower head A. When the connector 1 stretch to the main joint 2, the movable fixing structure hangs on the main joint in a fixation. The configuration and the remove of the shower head would be more convenient and quickly.

### INDUSTRIAL APPLICABILITY

A connector fixing structure for a shower head in the present invention has a movable clipping structure by the coordination of a movable fixing structure and a main joint connecting to the outlet on the top of the wall. A neck is disposed in the connector which molds in the shower head. When the connector is stretched to the main joint, the movable fixing structure hangs on the main joint in a fixation. So that the shower head and the main joint could match with each other at a motion of insert and plug. The configuration and the remove of the shower head would be more convenient and quickly in a good industrial utility.

1. A connecting and fixing structure for a shower head comprises a connector formed in the shower head, a main joint connecting to an outlet on the top of the wall, a movable fixing structure used for connecting the main joint and the connector; the movable fixing structure is movable sleeved on the main joint and is movably stretched to the main joint to form an elastic hook, and the connector sticks to the inside of the main joint and hangs on the hook.

2. The connecting and fixing structure for a shower head according to the claim 1, wherein the connector comprising an upper cylinder and a lower cylinder is a two-step stage column with thick above and thin down, a neck is disposed in the middle portion of the upper cylinder, and a groove is disposed on the top of the neck to embed an airproof ring.

3. The connecting and fixing structure for a shower head according to the claim 2, wherein both of the upper edge and the lower edge of the neck form an inclined leading face.

4. The connecting and fixing structure for a shower head according to the claim 1, wherein the inner diameter of the main joint adapts to the outer diameter of the connector, and the outer edge of the main joint forms three steps of stage growing thin, which are the upper, middle and lower cylinder, and plurality of symmetrical position holes are disposed close to the middle of the lower cylinder and a limit step is disposed at the bottom of the lower cylinder.

5. The connecting and fixing structure for a shower head according to the claim 4, wherein an inclined face is disposed at the bottom of the position holes.

6. The connecting and fixing structure for a shower head according to the claim 1, wherein the movable fixing structure comprises a snap-fit, a spring and a sliding sleeve; plurality of convex feet extend inside and upside at the bottom of the snap-fit, which hitches to the main joint, and the convex feet stretch to the position holes of the main joint, to form an elastic hook; the sliding sleeve is a sheath and the inside edge of the bottom of the sliding sleeve has flange ring, wherein plurality of position convex ribs are extended inwardly from the lower portion of the flange ring, and the spring is placed in the sliding sleeve downwardly; the bottom of the spring abut against the flange ring, and the sliding sleeve hitches to the main joint with the spring from the bottom of the main joint upward; the position convex ribs are abut against the limit step at the bottom of the main joint, while the top of the spring is abut against the step in the formation of the upper and the middle cylinder of the main joint.

7. The connecting and fixing structure for a shower head according to the claim 4, wherein the snap-fit is a sleeve ring, where plurality of convex feet extend inside and upside at the bottom, while equal amount of position holes are disposed correspondingly in the main joint.

8. The connecting and fixing structure for a shower head according to the claim 6, wherein in normal status the convex feet of the snap-fit are stretched to the position holes of the main joint correspondingly to form elastic hooks, and the convex abut against the neck of the main joint, and the flange ring of the sliding sleeve pushed alongside against the outer edge at the bottom of the snap-fit, forming a fixation.

9. The connecting and fixing structure for a shower head according to the claim 6, wherein the diameter of the circle surrounded by the upper end of the convex feet of the snap-fit is smaller than the outer diameter of the upper cylinder of the connector, steps are disposed at the outer edge of the top of the convex feet.

10. The connecting and fixing structure for a shower head according to the claim 6, wherein the shape of the convex feet at the bottom of the snap-fit conforms to the position holes of the main joint.

11. The connecting and fixing structure for a shower head according to the claim 6, wherein the snap-fit is a sleeve ring, where plurality of convex feet extend inside and upside at the bottom, while equal amount of position holes are disposed correspondingly in the main joint.
